(19) United States
(12) Patent Application Publication
(10) Pub. No.: US 2015/0002944 A1
(43) Pub. Date: Jan. 1, 2015

(54) IMAGING OPTICAL DEVICE

(71) Applicant: HIMAX TECHNOLOGIES LIMITED, Tainan City (TW)

(72) Inventor: CHUAN-HUI YANG, Tainan City (TW)

(73) Assignee: HIMAX TECHNOLOGIES LIMITED

(21) Appl. No.: 13/933,027

(22) Filed: Jul. 1, 2013

(51) Int. Cl. G02B 13/00

(52) U.S. Cl. CPC G02B 13/0045; G02B 13/0085
USPC 359/708; 359/754

(57) ABSTRACT

An imaging optical device includes a first lens group, which includes a first lens sub-group and a second lens sub-group that are physically connected without intermediate substance nor air existed therebetween and disposed in an order from an object side to an image side. The first lens sub-group has a positive refractive power, and the second lens sub-group has a negative refractive power.

### BACKGROUND OF THE INVENTION

1. Field of the Invention

The present invention generally relates to an imaging optical device, and more particularly to an imaging optical device composed of two lens groups.

2. Description of Related Art

Wafer level optics is a technique of fabricating miniaturized optics such as lens module or camera module at the wafer level using semiconductor techniques. The wafer level optics is well adapted to mobile or handheld devices, to which photograph has become an indispensable function.

As the size of an image sensor, such as a charge-coupled device (CCD) or a complementary metal-oxide-semiconductor image sensor (CIS), is scaled down, the photographic lens need be scaled down too.

Image lens design is a stringent process to achieve requirements such as low volume, light weight, low cost but high resolution. A general-purpose camera, either stand-alone or integrated with a handheld device such as a mobile phone, commonly uses two or more groups of image lenses in order to meet the high resolution demand. Each group includes two or three lenses that integrally accomplish required optical characteristics, and the two groups should also work together to achieve high performance.

In order to increase amount of incident light, more lens groups (e.g., four groups) are adopted. More lens groups, however, reduce incident light due to more light reflection or absorption. Accordingly, image lens with larger aperture should be designed, however, at the expense of higher manufacturing difficulty and cost.

Therefore, there is a need for a designer to propose a novel imaging optical device, particularly a wafer-level miniaturized optical device that has high image quality with low volume.

### SUMMARY OF THE INVENTION

In view of the foregoing, it is an object of the embodiment of the present invention to provide an imaging optical device with higher resolution and more incident light.

According to one embodiment, an imaging optical device includes at least a first lens group. The first lens group includes a first lens sub-group and a second lens sub-group that are physically connected and disposed in an order from the object side to the image side. The first lens sub-group has a positive refractive power, and the second lens sub-group has a negative refractive power. The imaging optical device may further include a second lens group having a negative refractive power, and the first lens group and the second lens group are disposed in an order from the object side to the image side. The first lens sub-group includes at least a first lens, a second lens and a third lens disposed in the order from the object side to the image side, and the second lens sub-group includes at least a fourth lens, a fifth lens and a sixth lens disposed in the order from the object side to the image side. An image-side surface of the third lens is in physical contact with an object-side surface of the fourth lens without intermediate substance nor air existed therebetween.

### BRIEF DESCRIPTION OF THE DRAWINGS

FIG. 1 shows a lens arrangement of an imaging optical device according to one embodiment of the present invention;

FIG. 2A and FIG. 2B show some performances of the imaging optical device according to one exemplary embodiment; and

FIG. 3A and FIG. 3B show some performances of the imaging optical device according to another exemplary embodiment.

### DETAILED DESCRIPTION OF THE INVENTION

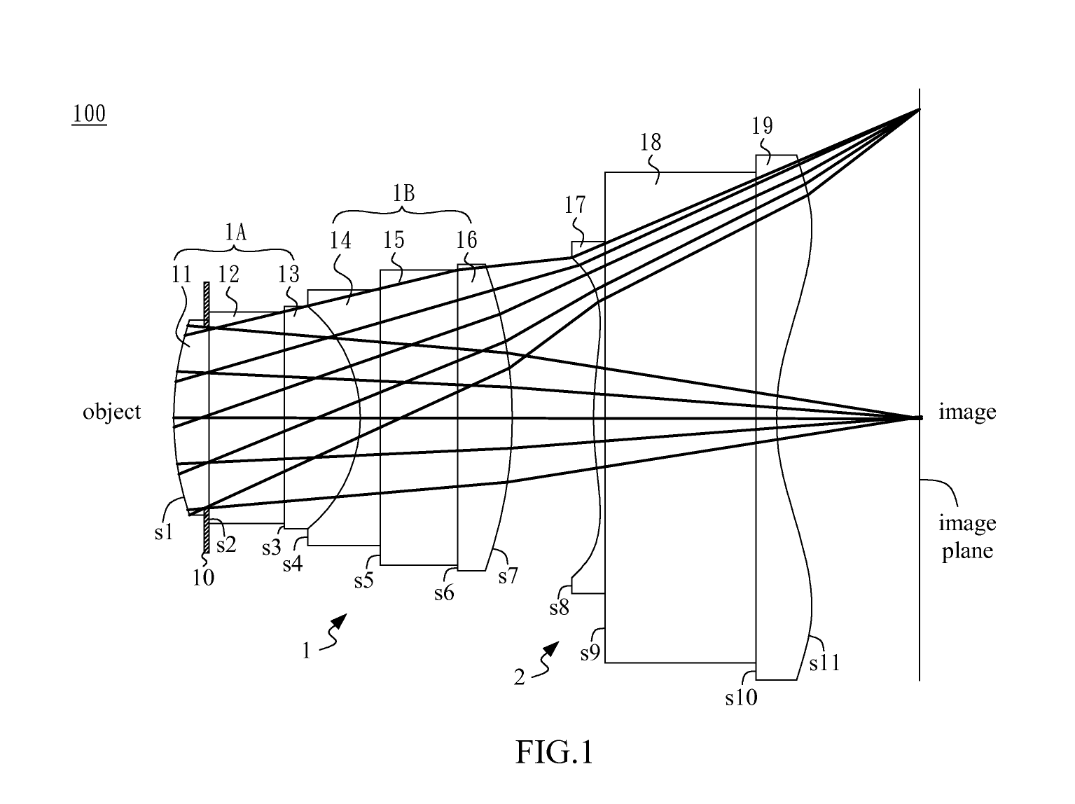

FIG. 1 shows a lens arrangement of an imaging optical device 100 according to one embodiment of the present invention. The imaging optical device 100 of the embodiment may particularly be a wafer-level image lens that is fabricated by semiconductor techniques. According to present technology advancement, lens form of the wafer-level image lens may be less than 1 μm. Alternatively, the imaging optical device 100 may be a miniature image lens that is fabricated by techniques other than wafer-level techniques.

As shown in FIG. 1, the left side of the imaging optical device 100 faces an object, and the right side of the imaging optical device 100 faces an image (or an image plane). In the embodiment, the imaging optical device 100 includes two lens groups: a first lens group 1 and a second lens group 2 in the order from the object side to the image side. The first lens group 1 further has a first lens sub-group 1A and a second lens sub-group 1B, that are physically connected, in the order from the object side to the image side. The first lens sub-group 1A acts as a positive lens having a positive refractive power, the second lens sub-group 1B acts as a negative lens having a negative refractive power, and the second lens group 2 acts as a negative lens having a negative refractive power.

In the embodiment, the first lens sub-group 1A includes at least three lenses: a first lens 11, a second lens 12 and a third lens 13 in the order from the object side to the image side. The second lens sub-group 1B includes at least three lenses: a fourth lens 14, a fifth lens 15 and a sixth lens 16 in the order from the object side to the image side. The second lens group 2 includes at least three lenses: a seventh lens 17, an eighth lens 18 and a ninth lens 19 in the order from the object side to the image side.

Specifically, the first lens 11 has a convex object-side aspheric surface s1. The first lens 11 has an image-side surface s2 in substantially contact with an object-side surface s2 of the second lens 12. The surface s2 of the embodiment is coated with an aperture layer (STOP) 10 that is lithographically patterned using a semiconductor technique. The second lens 12 has an image-side surface s3 in substantially contact with an object-side surface s3 of the third lens 13. The third lens 13 has a convex image-side aspheric surface s4 in substantially contact with a concave object-side aspheric surface s4 of the fourth lens 14. In the embodiment, the convex image-side aspheric surface s4 of the third lens 13 is in physical contact with the concave object-side aspheric surface s4 of the fourth lens 14 without intermediate substance nor air existed therebetween. This may be done with an impress process, by which the third lens 13 and the fourth lens 14 are bonded while they are being formed, therefore no glue is needed for their bonding. The fourth lens 14 has an image-side surface s5 in substantially contact with an object-side surface so of the fifth lens 15. The fifth lens 15 has an image-side surface s6 in substantially contact with an object-side surface s6 of the sixth lens 16. The sixth lens 16 has a convex image-side aspheric surface s7. In the exemplary embodiment, the surface s2, s3, s5 and s6 may, but is not limited to, be planar.

Moreover, the seventh lens 17 has a convex object-side aspheric surface s8. The seventh lens 17 has an image-side surface s9 in substantially contact with an object-side surface s9 of the eighth lens 18. The eighth lens 18 has an image-side surface s10 in substantially contact with an object-side surface s10 of the ninth lens 19. The ninth lens 19 has a concave image-side aspheric surface s11. In the exemplary embodiment, the surface s9 and s10 may, but is not limited to, be planar.

According to one aspect of the embodiment, a refractive index of the third lens 13 is different from (for example, smaller than) a refractive index of the fourth lens 14. Specifically speaking, in the embodiment, the refractive index of the third lens 13 is in a range between 1.55 and 1.5; and the refractive index of the fourth lens 14 is in a range between 1.55 and 1.63.

According to another aspect of the embodiment, a dispersion index (or Abbe number) of the third lens 13 is different from (for example, larger than) a dispersion index of the fourth lens 14. Specifically speaking, in the embodiment, the dispersion index of the third lens 13 is in a range between 55 and 40; and the dispersion index of the fourth lens 14 is in a range between 35 and 25.

According to a further aspect of the embodiment, the second lens 12, the fifth lens 15 and the eighth lens 18 have a refractive index being in a range between 1.63 and 1.5; and the second lens 12, the fifth lens 15 and the eighth lens 18 have a dispersion index being in a range between 60 and 40.

According to a further aspect of the embodiment, a ratio of effective focal lengths of the first lens sub-group 1A and the second lens sub-group 1B is in a range between −0.6 and −0.9.

In one exemplary embodiment, an infra-red (IR) filter may be coated on at least one of the surfaces of the second lens 12 and the fifth lens 15 (e.g., glass plate).

Table 1 shows some surface data according to a first exemplary embodiment, where the thickness and the radius may be unitless or in the unit, for example, of millimeter (mm). A focal length of the imaging optical device 100 is 2.11 mm, an F number (i.e., focal ratio) is 2.8, and a half of field of view (DFOV) is 29.6.

TABLE 1

| | | | | Refractive | Dispersion |
|---|---|---|---|---|---|
| Surface | Radius | Thickness | Material | index | index |
| s1 | 1.364358 | 0.14 | rubber/ | 1.577 | 31.4 |
| | | | plastic | | |
| s2 (STOP) | infinity | 0.3 | glass | 1.51 | 61.1 |
| s3 | infinity | 0.315 | rubber/ | 1.52 | 48.7 |
| | | | plastic | | |
| s4 | −0.5861015 | 0.064 | rubber/ | 1.577 | 31.4 |
| | | | plastic | | |
| s5 | infinity | 0.3 | glass | 1.51 | 61.1 |
| s6 | infinity | 0.218 | rubber/ | 1.577 | 31.4 |
| | | | plastic | | |
| s7 | −5.773716 | 0.32 | air | | |
| s8 | 1.573934 | 0.04 | rubber/ | 1.577 | 31.4 |
| | | | plastic | | |
| s9 | infinity | 0.6 | glass | 1.51 | 61.1 |
| s10 | infinity | 0.078 | rubber/ | 1.577 | 31.4 |
| | | | plastic | | |
| s11 | 1.036174 | 0.57 | air | | |

The aspheric surface (e.g., s1, s4, s7, s8 or s11) may be defined by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} + {α}_{9} {r}^{18}$$

where a₁=0 for all surfaces, z is a distance from the vertex of lens in the optical axis direction, r is a distance in the direction perpendicular to the optical axis, c is a reciprocal of radius of curvature on vertex of lens, k is a conic constant and a₁ to a₉ are aspheric coefficients. Table 2 shows exemplary constants and coefficients associated with the equation according to the first exemplary embodiment.

TABLE 2

| | k | α₂ | α₃ | α₄ |
|---|---|---|---|---|
| s1 | −77.16656 | 2.8515687 | −26.333677 | 156.64093 |
| s4 | | −2.0168111 | 19.113052 | −98.824451 |
| s7 | | −0.87831426 | 1.9608627 | −0.51743239 |
| s8 | −32.75248 | −0.41159125 | −1.0530914 | −5.5139332 |
| s11 | −0.8068494 | −0.64541256 | 0.50435308 | −0.58641423 |

| | α₅ | α₆ | α₇ | α₈ | α₉ |
|---|---|---|---|---|---|
| s1 | −404.34278 | −388.2975 | 3391.6082 | −2139.1637 | |
| s4 | 249.14666 | 60.269986 | 131.19558 | −5123.6605 | |
| s7 | −23.907241 | 93.420886 | −149.52658 | 87.719279 | |
| s8 | 33.187284 | −8.8146531 | −342.67264 | 880.16681 | −686.163 |
| s11 | 0.89763349 | −1.0302326 | 0.59410101 | −0.13013665 | |

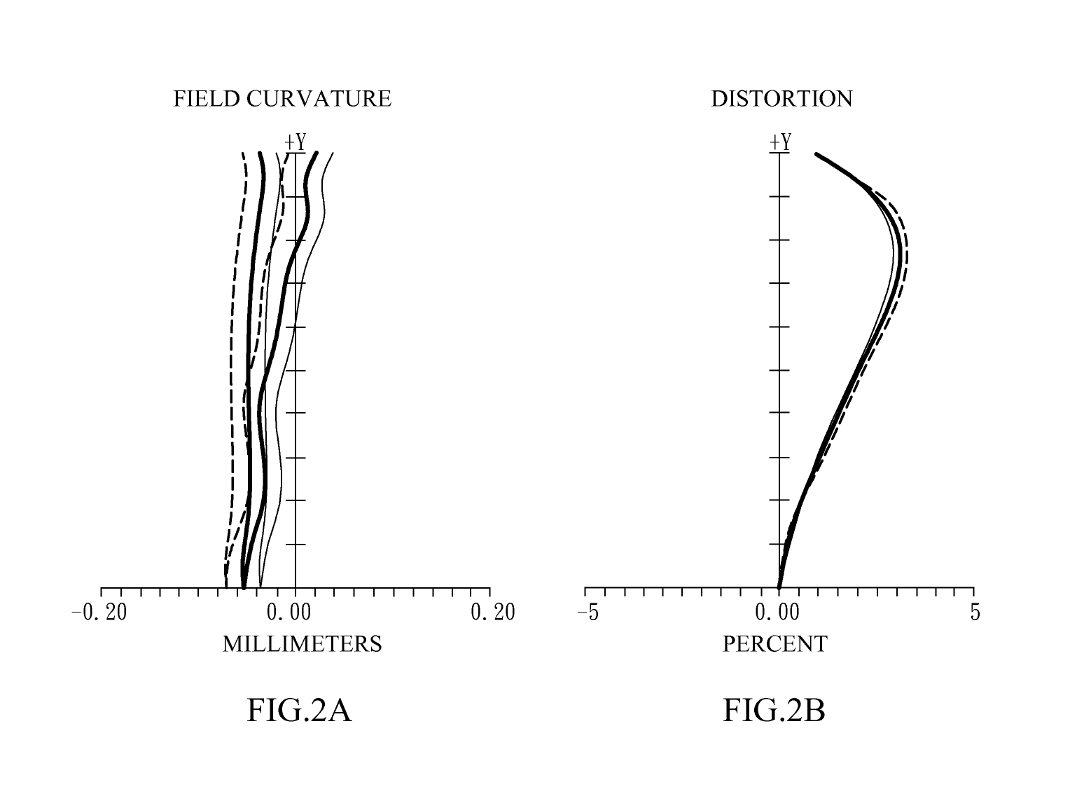

FIG. 2A and FIG. 2B show some performances of the imaging optical device 100 according to the first exemplary embodiment. Specifically, FIG. 2A shows field curvature and FIG. 2B shows distortion.

Table 3 shows some surface data according to a second exemplary embodiment, where the thickness and the radius may be unitless or in the unit, for example, of millimeter (mm). A focal length of the imaging optical device 100 is 2.208 mm, an F number (i.e., focal ratio) is 2.8, and a half of field of view (DFOV) is 28.5.

TABLE 3

| | | | | Refractive | Dispersion |
|---|---|---|---|---|---|
| Surface | Radius | Thickness | Material | index | index |
| s1 | 1.1326 | 0.16 | rubber/ | 1.52 | 48.7 |
| | | | plastic | | |
| s2 | infinity | 0.5 | glass | 1.51 | 61.1 |
| s3 | infinity | 0.245 | rubber/ | 1.52 | 48.7 |
| | | | plastic | | |
| s4 | −0.8957 | 0.03 | rubber/ | 1.577 | 31.4 |
| | | | plastic | | |
| s5 (STOP) | infinity | 0.3 | glass | 1.51 | 61.1 |
| s6 | infinity | 0.138 | rubber/ | 1.577 | 31.4 |
| | | | plastic | | |
| s7 | 112.97 | 0.287 | Air | | |
| s8 | 1.959 | 0.048 | rubber/ | 1.577 | 31.4 |
| | | | plastic | | |
| s9 | infinity | 0.6 | glass | 1.51 | 61.1 |
| s10 | infinity | 0.1 | rubber/ | 1.577 | 31.4 |
| | | | plastic | | |
| s11 | 1.2 | 0.535 | Air | | |

Table 4 shows exemplary constants and coefficients associated with the above equation according to the second exemplary embodiment.

TABLE 4

| | k | α₂ | α₃ | α₄ |
|---|---|---|---|---|
| s1 | −46.8116 | 3.0796213 | −26.385427 | 154.15548 |
| s4 | | −2.7049614 | 24.969996 | −141.90018 |
| s7 | | −0.84289662 | 2.0430608 | −0.35938161 |
| s8 | −51.15348 | −0.49640459 | −1.000909 | −4.8608313 |
| s11 | −0.4186698 | −0.54769671 | 0.30961412 | −0.46231547 |

| | α₅ | α₆ | α₇ | α₈ | α₉ |
|---|---|---|---|---|---|
| s1 | −418.60446 | −377.01823 | 4825.2871 | −7585.0223 | |
| s4 | 462.94026 | −510.46726 | −132.10426 | −452.56897 | |
| s7 | −24.094555 | 94.889262 | −148.33653 | 81.908932 | |
| s8 | 31.325844 | −4.3120796 | −366.59513 | 944.27473 | −737.03075 |
| s11 | 0.89411007 | −1.0492677 | 0.58262556 | −0.12135508 | |

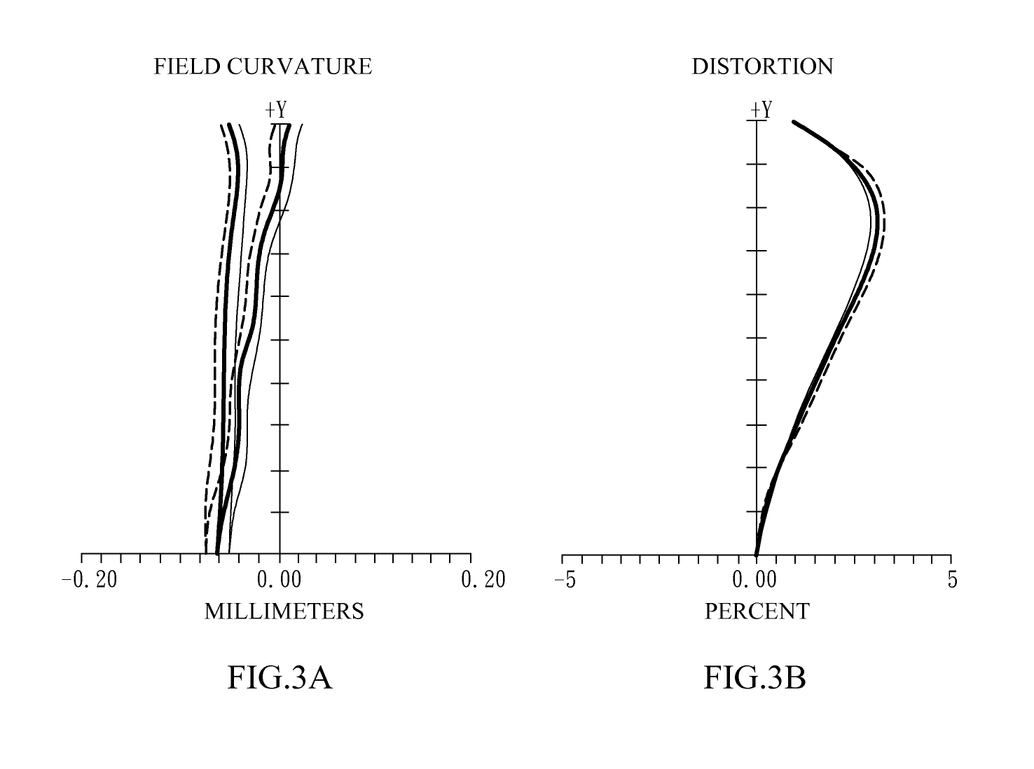

FIG. 3A and FIG. 3B show some performances of the imaging optical device 100 according to the second exemplary embodiment. Specifically, FIG. 3A shows field curvature and FIG. 3B shows distortion.

According to the embodiments described above, an imaging optical device 100 with two lens groups is proposed to obtain an amount of incident light and resolution as large as an imaging optical device with three or more lens groups, thereby substantially reducing overall volume and simplifying manufacturing complexity.

Although specific embodiments have been illustrated and described, it will be appreciated by those skilled in the art that various modifications may be made without departing from the scope of the present invention, which is intended to be limited solely by the appended claims.

What is claimed is:

1. An imaging optical device, comprising:
a first lens group including a first lens sub-group and a second lens sub-group that are physically connected and disposed in an order from an object side to an image side, the first lens sub-group having a positive refractive power and the second lens sub-group having a negative refractive power;
wherein the first lens sub-group includes at least a first lens, a second lens and a third lens disposed in the order from the object side to the image side, and the second lens sub-group includes at least a fourth lens, a fifth lens and a sixth lens disposed in the order from the object side to the image side; and
wherein an image-side surface of the third lens is in physical contact with an object-side surface of the fourth lens without intermediate substance nor air existed therebetween.

2. The imaging optical device of claim 1, further comprising:
a second lens group having a negative refractive power;
wherein the first lens group and the second lens group are disposed in an order from the object side to the image side.

3. The imaging optical device of claim 1, further comprising an aperture layer coated on an object-side surface of the second lens.

4. The imaging optical device of claim 2, wherein the second lens group comprises at least a seventh lens, an eighth lens and a ninth lens disposed in the order from the object, side to the image side.

5. The imaging optical device of claim 1, wherein the first lens has a convex object-side aspheric surface, the first lens has an image-side surface in substantially contact with an object-side surface of the second lens, the second lens has an image-side surface in substantially contact, with an object-side surface of the third lens, the third lens has a convex image-side aspheric surface in substantially contact with a concave object-side aspheric surface of the fourth lens, the fourth lens has an image-side surface in substantially contact with an object-side surface of the fifth lens, the fifth lens has an image-side surface in substantially contact, with, an object-side surface of the sixth lens, and the sixth lens has a convex image-side aspheric surface.

6. The imaging optical device of claim 5, wherein the object-side surface of the second lens, the image-side surface of the second lens, the object-side surface of the fifth lens, and the image-side surface of the fifth lens are planar.

7. The imaging optical device of claim 4, wherein the seventh lens has a convex object-side aspheric surface, the seventh lens has an image-side surface in substantially contact with an object-side surface of the eighth lens, the eighth lens has an image-side surface in substantially contact with an object-side surface of the ninth lens, and the ninth lens has a concave image-side aspheric surface.

8. The imaging optical device of claim 7, wherein the object-side surface of the eighth lens and the image-side surface of the eighth lens are planar.

9. The imaging optical device of claim 1, wherein the third lens has a convex image-side aspheric surface in physical contact with a concave object-side aspheric surface of the fourth lens.

10. The imaging optical device of claim 1, wherein the third lens has a refractive index different from a refractive index of the fourth lens.

11. The imaging optical device of claim 10, wherein the third lens has a refractive index smaller than a refractive index of the fourth lens.

12. The imaging optical device of claim 11, wherein the refractive index of the third lens is in a range between 1.55 and 1.5, and the refractive index of the fourth lens is in a range between 1.55 and 1.63.

13. The imaging optical device of claim 1, wherein the third lens has a dispersion index different from a dispersion index of the fourth lens.

14. The imaging optical device of claim 13, wherein the third lens has a dispersion index larger than a dispersion index of the fourth lens.

15. The imaging optical device of claim 14, wherein the dispersion index of the third lens is in a range between 55 and 40, and the dispersion index of the fourth lens is in a range between 35 and 25.

16. The imaging optical device of claim 4, wherein the second lens, the fifth lens and the eighth lens have a refractive index being in a range between 1.63 and 1.5; and the second lens, the fifth lens and the eighth lens have a dispersion index being in a range between 60 and 40.

17. The imaging optical device of claim 2, wherein a ratio of effective focal lengths of the first lens sub-group and the second lens sub-group is in a range between −0.6 and −0.9.

18. The imaging optical device of claim 1, further comprising an infra-red (IR) filter coated on at least one surface of the second lens and the fifth lens.
